(19) United States
(12) Patent Application Publication
(10) Pub. No.: US 2019/0090216 A1
(43) Pub. Date: Mar. 21, 2019

(54) KEY LOCATING SYSTEM

(71) Applicant: Ronald D. Carder, Summerton, SC (US)

(72) Inventor: Ronald D. Carder, Summerton, SC (US)

(21) Appl. No.: 15/710,427

(22) Filed: Sep. 20, 2017

(51) Int. Cl. H04W 64/00; G06F 3/048; H04W 4/02

(52) U.S. Cl. CPC H04W 64/003; H04W 4/02; G06F 3/048

(57) ABSTRACT

A smart key locating system that includes: a GPS transmitter placed on the smart key; a GPS signal transmitted to a base station via a network from the GPS transmitter; location data within the GPS signal; and a personal electronic device, where the personal electronic device receives the location data on demand via the network. The smart key locating system also includes a user interface on the personal electronic device, where the personal electronic device may be selected from a group consisting of a smartphone, tablet, personal computer or laptop. The user interface is accessible through the network within a software application.

### BACKGROUND OF THE INVENTION

### Field of Invention

The present invention relates to a smart key locating system.

### Description of Related Art

Smart keys are used frequently with motor vehicles where keyless entry is provided through the smart key. A smart key usually includes sensors that are activated upon proximity to the vehicle to enable the user to use a push button start mechanism. Further the smart key may engage and implement other aspects of the vehicle such as alarm systems, location systems and other mechanisms that have been developed through the use of smart keys. Smart keys are very handy and useful devices that have been implemented into modern vehicles. As with any key it is essential to have the location of the key available at all times in order to gain entry and to operate the vehicle. As a result, it would be advantageous to have an electronic system implemented on the smart key that helps the user to locate the key through the use of a portable electronic device such as a cell phone.

### SUMMARY OF THE INVENTION

The present invention relates to a smart key locating system that includes: a GPS transmitter placed on the smart key; a GPS signal transmitted to a base station via a network from the GPS transmitter; location data within the GPS signal; and a personal electronic device, where the personal electronic device receives the location data on demand via the network. The smart key locating system also includes a user interface on the personal electronic device, where the personal electronic device may be selected from a group consisting of a smartphone, tablet, personal computer or laptop. The user interface is accessible through the network within a software application.

### BRIEF DESCRIPTION OF DRAWINGS

FIG. 1 depicts a smart key location system according to the present invention.

### DETAIL DESCRIPTION

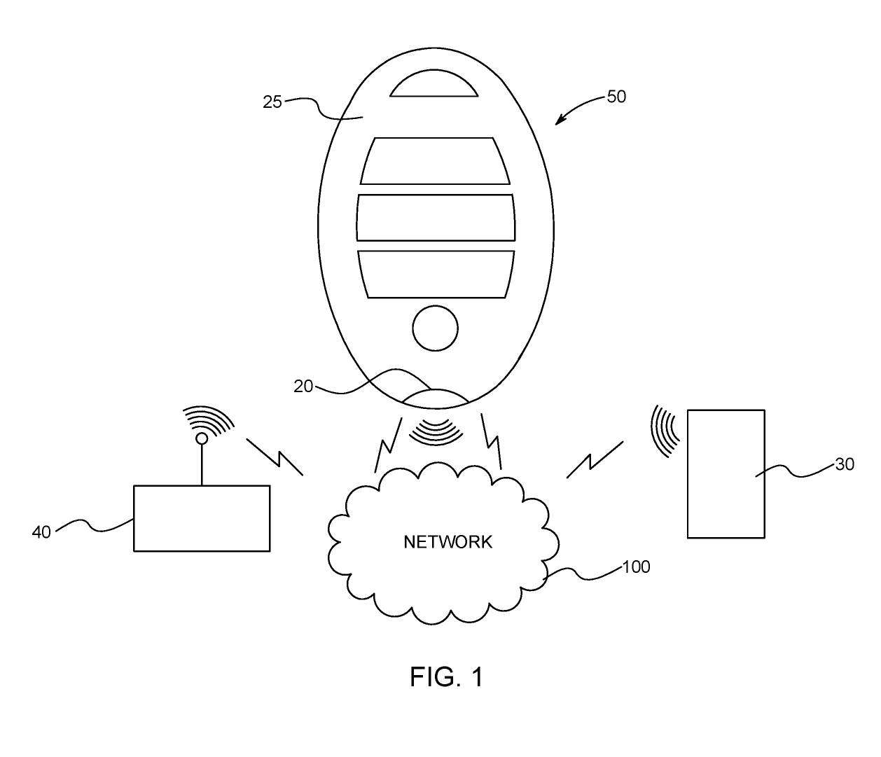

The present invention implements a transducer which emits a continuous locating signal to a GPS network. This signal is received by a base station and data is provided as to the location of the smart key. In reference to FIG. 1, smart key 50 is shown in accordance with the present invention. The smart key 50 includes a GPS transmitter 20 integrated into the smart key 50. The smart key 50 connects to a network 100 and transmits to a GPS base station 40. The GPS base station 40 provides location and positioning data to a personal electronic device (PED) 30 shown connected to a communications network 100. This data is shared on demand to the user to locate smart key 50. This data is continuously supplied to a user interface accessible through the PED 30. The PED 30 may be any conventional portable electronic device such as a smartphone, a tablet, personal computer or laptop. This locating system associated with the smart key provides the user with a means to locate any lost key via their smart phone.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. A smart key locating system comprising:
a. a GPS transmitter placed on the smart key;
b. a GPS signal transmitted to a base station via a network from the GPS transmitter;
c. location data within the GPS signal; and
d. a personal electronic device, where the personal electronic device receives the location data on demand via the network.

2. The smart key locating system according to claim 1, further comprising a user interface on the personal electronic device.

3. The smart key locating system according to claim 1, where the personal electronic device includes at least one of a smartphone, tablet, personal computer or laptop.

4. The smart key locating system according to claim 1, where the user interface is accessible through the network.
